(19) United States
(12) Patent Application Publication
(10) Pub. No.: US 2026/0268081 A1
(43) Pub. Date: Sep. 10, 2026

(54) INFORMATION PROCESSING DEVICE

(71) Applicant: Preferred Networks, Inc., Tokyo (JP)

(72) Inventor: Daisuke OKANOHARA, Tokyo (JP)

(73) Assignee: Preferred Networks, Inc., Tokyo (JP)

(21) Appl. No.: 19/662,010

(22) Filed: Apr. 29, 2026

Related U.S. Application Data
(63) Continuation of application No. PCT/JP2024/038632, filed on Oct. 30, 2024.

(30) Foreign Application Priority Data
Oct. 31, 2023 (JP) 2023-186992

(51) Int. Cl. G06F 40/284; G06F 21/16; G06F 40/40

(52) U.S. Cl. CPC G06F 40/284; G06F 21/16; G06F 40/40

(57) ABSTRACT

An information processing device includes one or more processors and one or more memories. The one or more memories storing processor-executable instructions that, when executed by the one or more processors, cause the one or more processors to acquire, using a generative model based on one or more preceding tokens, multiple tokens as candidates for a next token succeeding the one or more preceding tokens, and select, from among the multiple tokens, a token as the next token based on information used for embedding a watermark, thereby embedding the watermark in an output token sequence.

This application is continuation application of International Application No. JP2024/038632, filed on October 30, 2024, which claims priority to Japanese Application No. 2023-186992, filed on October 31, 2023, the entire contents of which are incorporated herein by reference

### FIELD

### CROSS REFERENCE TO THE RELATED APPLICATIONS

The present disclosure relates to an information processing device.

### BACKGROUND

There is a technique for embedding a digital watermark in text generated from a large language model. If a digital watermark is detected in a piece of text, it can be determined that the text was generated by a large language model.

### BRIEF DESCRIPTION OF DRAWINGS

FIG. 1 is a diagram schematically illustrating an example of token generation according to one embodiment.

FIGS. 2 and 3 are diagrams schematically illustrating an example of a token sequence according to some embodiments.

FIG. 4 is a diagram schematically illustrating an example of embedding information acquisition according to one embodiment.

FIG. 5 is a diagram schematically illustrating a non-limiting application example according to one embodiment.

FIG. 6 is a diagram illustrating an example implementation of an information processing device according to one embodiment.

### DETAILED DESCRIPTION

According to one embodiment, an information processing device includes one or more processors and one or more memories. The one or more memories storing processor-executable instructions that, when executed by the one or more processors, cause the one or more processors to acquire, using a generative model based on one or more preceding tokens, multiple tokens as candidates for a next token succeeding the one or more preceding tokens, and select, from among the multiple tokens, a token as the next token based on information used for embedding a watermark, thereby embedding the watermark in an output token sequence.

The problems to be solved by the embodiments of the present disclosure are not limited to those described above; they may also include problems corresponding to effects described in the embodiments as further non-limiting examples. That is, any problem corresponding to at least one of the effects described in the embodiments of the present disclosure may be treated as a problem to be solved by the present disclosure.

Embodiments will be described with reference to the drawings. The drawings and descriptions of the embodiments are presented by way of example and do not limit the present invention.

For example, in the present disclosure, the description mainly covers cases where text data such as characters and sentences is used as information in a language model; however, embodiments are not limited thereto and can also be applied to data such as images, audio, video, and sensor data. These types of data can be similarly applied in the embodiments by being appropriately tokenized.

In the present disclosure, non-limiting examples of an information processing device that embeds information into data and an information processing device that reads information from data will be described.

The information processing device according to the present disclosure comprises one or more memories and one or more processors. In addition, the information processing device may optionally include a power supply unit, an interface, or other components necessary for its operation. Hereinafter, "one or more memories" may be referred to simply as "memory," and "one or more processors" may be referred to simply as "processor."

At least one of the one or more memories may be external to the information processing device, and at least one of the one or more processors may also be external to the information processing device. When at least one memory or at least one processor is external, the information processing device described as a non-limiting example in the present disclosure may operate as at least part of an information processing system.

### Embodiment Relating to an Embedding Device

As a non-limiting example, the information processing device generates data using a generative model for some type of data and simultaneously embeds information in the generated data. The generative model may be, for example, a large language model, but is not limited thereto. The generative model according to the present disclosure may be, for example, any model capable of dividing generated data into tokens.

Furthermore, the information processing device may be configured to embed information into data using a model that modifies data. Similarly to the above, this model may be, for example, any model capable of dividing the data to be modified into tokens. By using this model, the information processing device can, for example, embed information into data generated by the aforementioned generative model after the data has been generated.

When a modification model is used, the phrase "data to be generated" in the following description can be read as "data to be modified." The information processing device can, for example, modify some tokens of data that can be divided into tokens, thereby embedding embedding information in the target data.

It should also be noted that in the present disclosure, embedding embedding information in data and embedding embedding information in a token sequence constituting data may refer to the same process.

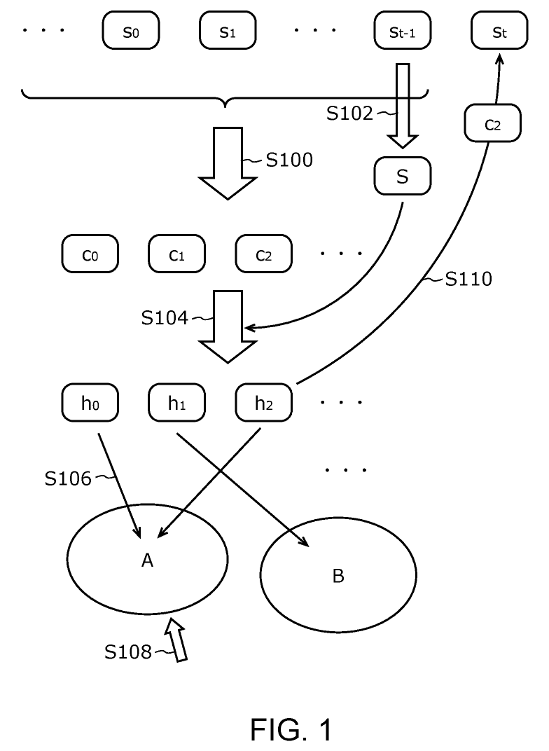

FIG. 1 is a diagram schematically illustrating token generation processing according to one embodiment. Tokens generated up to the current point in time are denoted s₀ through sₜ₋₁. The processor generates, using the immediately preceding token sₜ₋₁ as a first token, a second token sₜ based on this first token.

The output data outputted by the processor is, for example, data obtained by concatenating s₀ through the final token s_{N}. s_{N} may be a token indicating the end of data. In this case, the output data is represented as a token sequence formed by concatenating N tokens, s₀ through s_{N-1}.

The processor embeds one piece of information (hereinafter, "embedding information") into these N tokens. The embedding information may be any information. The generation of data with this embedding information embedded therein will be described in detail below.

The processor generates a plurality of candidates (token candidates) c₀, c₁, c₂, ... for the next token based on past tokens (S100). This generation is not particularly limited, for example, the processor may generate tokens using rule-based generation or using a generative model. That is, the plurality of candidates for the second token sₜ are generated based on at least the previously generated first token sₜ₋₁.

The processor generates a hash seed S from the first token sₜ₋₁ in parallel with, or before or after, the generation of the token candidates described above (S102). The processor transforms the first token sₜ₋₁ into a hash value using a predetermined hash seed defined in advance, and based on this hash value, calculates a hash seed S to be used for transforming (hashing) each token candidate into a hash value. Any reversible or irreversible transformation may be used for the transformation from a hash value to a hash seed. This transformation may also be a linear or nonlinear transformation.

The processor calculates respective hash values h₀, h₁, h₂, ... for the plurality of candidates c₀, c₁, c₂, ... using the hash seed S (S104). That is, the processor hashes each of the plurality of candidates.

As described above, the processor transforms the plurality of candidates for the second token according to a predetermined rule and obtains a value corresponding to each candidate. That is, the predetermined rule may be, as a non-limiting example, a transformation that includes at least calculation of a hash value.

The calculation of this hash value may, as a non-limiting example, include a transformation using a predetermined hash seed and the first token sₜ₋₁.

As a more specific but non-limiting example, the hash seed S used for this hashing may be a value related to a hash value obtained by transforming the first token sₜ₋₁ using the predetermined hash seed.

As a further non-limiting example, the predetermined rule may be a transformation that obtains the hash value of the candidate using the obtained hash seed S.

The above is presented as one example and does not exclude other approaches. In another non-limiting example, the processor may adopt, as the predetermined rule, a transformation that has no bias or little bias with respect to some metric for the plurality of candidates.

The processor classifies the candidates c₀, c₁, c₂, ... for the second token into groups based on the hash values h₀, h₁, h₂, ... (S106). Any classification method may be used. For example, the processor classifies the candidates for the second token into groups based on any classification method, such as applying a predetermined threshold to the hash values, using an even/odd approach for the hash values, or distributing them by a predetermined method for each hash value.

The groups may be, for example, two groups such as Group A and Group B as shown in the figure. As one example, the processor may assign the value 0 to Group A and the value 1 to Group B. That is, in a non-limiting example, the processor classifies the candidates into a group representing a value of 0 and a group representing a value of 1 based on the transformation in S104. These "0" and "1" can correspond to bit values.

Note that the processing of S102 and S104 described above, together with this classification, can be included in the predetermined rule. In this case, it is sufficient if the configuration is capable of properly classifying the plurality of second token terms into groups.

The processor selects a group based on whether the next bit in the bit sequence — which is based on the groups into which tokens s₀, s₁, ..., sₜ₋₁ were classified in S106 in the past — should be 0 or 1 (S108). The processor selects the group for the second token sₜ such that the bit sequence representing the embedding information (e.g., some identifier) to be embedded as a digital watermark matches the bit sequence formed by concatenating the values based on the groups of the respective tokens.

That is, the processor selects a group representing the appropriate value (0 or 1) to append (concatenate) to the bit sequence corresponding to the already-generated token sequence s₀, s₁, ..., sₜ₋₁. In the following, an identifier will be used as an example of the embedding information.

For example, the processor selects Group A if the (t+1)-th bit (append data) from the front of the embedding information — which is a bit sequence (data sequence) representing the identifier — is 0, and selects Group B if it is 1.

The processor selects one candidate from the candidates belonging to the selected group as the second token sₜ (S110). For example, as shown in the figure, when the next bit to be appended is 0, the processor selects Group A and chooses candidate c₂ from the candidates belonging to Group A as the second token sₜ.

In this way, the processor selects the second token sₜ such that the concatenation of the values associated with the groups of tokens s₀ through the first token sₜ₋₁ and the second token sₜ forms a prefix match (i.e., constitutes part or all of the embedding information from the front) of the data sequence representing the identifier.

In other words, when one more bit selection will complete the embedding information, the processor selects the second token sₜ such that the embedding information — formed by concatenating the classification result (0 or 1) of each token — matches the data associated with the identifier; when the embedding is still in progress, the processor selects the second token sₜ such that the embedding information matches the front portion of the data associated with the identifier.

By sequentially and repeatedly making selections starting from the 0th token so as to match the data sequence representing the identifier, the data sequence representing the identifier can be embedded in a sequence of consecutive tokens. By repeatedly executing this process, the processor can embed the embedding information as a digital watermark in the token sequence.

After the data sequence representing the identifier (the embedding information) has been embedded, the processor may select tokens by any method, as a non-limiting example.

As a non-limiting example, after the embedding information has been embedded, the processor may also append an error detection code or error correction code for the embedding information by repeating the same token selection process. By appending such a code, appropriate error detection or error correction can be performed even if the data has been tampered with or part of the data has been corrupted by noise or similar disturbances during transmission. This error detection code or error correction code may have any number of digits.

The data sequence representing the identifier may be predetermined to have a fixed number of digits. Alternatively, the processor may append a bit sequence indicating an end flag, using the process described above, at the terminal position of the embedding information or the embedding information with the appended code.

As another example, the processor may repeatedly embed the embedding information or the embedding information with the appended code.

In this way, the processor generates output data by concatenating tokens, and can embed the identifier using the values based on the groups to which each token belongs.

Note that the number of groups for classification need not be two; three or more groups may also be used. Classifying into more than two groups can broaden the range expressible by the embedding information related to the identifier. On the other hand, classifying into more than two groups narrows the range of token selection, and in particular, when the entropy of the tokens constituting the output data is low, the margin for token selection may become very limited or nonexistent. Therefore, it is desirable to choose a number of groups that maintains an appropriate balance.

As described above, according to the information processing device of the present embodiment, when generating data using a generative model, it becomes possible to control the information to be embedded as a digital watermark in that data, and as a result, it becomes possible to embed arbitrary embedding information (bit sequences) in the data.

According to this method, it becomes possible to embed arbitrary embedding information as a digital watermark. The embedding information embedded in the data may be an identifier representing some predetermined type of information. For example, it may be an identifier representing the entity (individual or organization) that generated the data using the generative model or instructed the generative model to generate it, an identifier representing the date on which the data was generated by the generative model, or an identifier representing the generative model that generated the data.

Furthermore, in Retrieval Augmented Generation (RAG), the embedding information may be an identifier representing the provider (individual or organization) of information found through a retrieval process conducted when generating data using a generative model, or an identifier representing that information.

The embedding information embedded in the data may also be an identifier representing information related to the use of the data — for example, information indicating that reproduction of the data is prohibited, or information indicating the scope of use of the data. Of course, the identifier may also be a value carrying any other arbitrary information.

Note that the first token relative to the second token need not be the immediately preceding token. That is, for example, the token two positions before the currently targeted token can be selected as the first token.

Furthermore, when the second token is token s₀ (i.e., when determining the first token), the processor may treat the result of dividing the input data entered to generate the output data into tokens as tokens s_{M}, s_{M-1}, ..., s₋₁ (where M is the number of tokens in the input data), and use the token with a negative index — for example, token s₋₁ — as the first token. By doing so, the embedding information (bit sequence) can be embedded sequentially starting from the leading token of the generated token sequence.

As another example, after generating token s₀, the processor may skip the classification of token s₀ and instead begin embedding information with the classification result of token s₁ based on token s₀ as the starting bit. By doing so, the embedding information (bit sequence) can be embedded not from the leading token of the generated token sequence, but sequentially from the second token onward.

In the above embodiments, individual tokens were used; however, the form according to the present disclosure is not limited thereto. The processor can perform the same process as described above on a token sequence comprising a predetermined number of tokens.

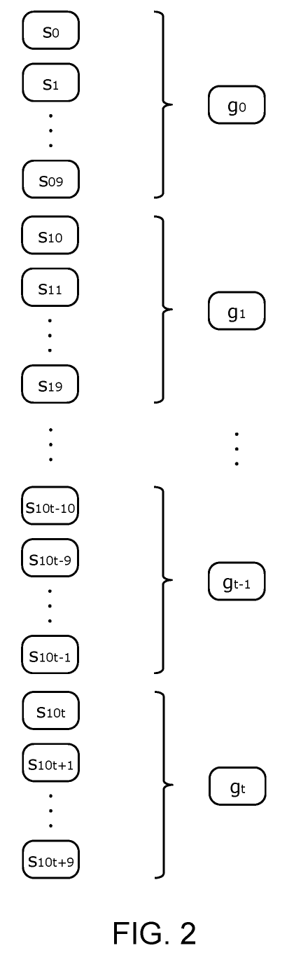

FIG. 2 is a diagram illustrating an example in which not one token but multiple tokens — as a non-limiting example, 10 consecutive tokens — form one token sequence. As shown in this figure, the processor groups multiple consecutive tokens together as a single token sequence and classifies the token sequence into a group (0 or 1).

This allows the processor to embed, for each token sequence unit (every multiple tokens), one bit's worth of information constituting the bit sequence representing the identifier, for example. As a result, the processor can embed the identifier's information in a token sequence formed by concatenating multiple token sequences. That is, by embedding the bit sequence representing the embedding information one bit at a time for every multiple tokens, the processor can embed one piece of embedding information in multiple token sequences.

In this case, the processor generates multiple tokens at once. As a non-limiting example, the processor can generate each token constituting the token sequence based on joint probability. The processor generates a plurality of candidates for the second token sequence gₜ based on joint probability, classifies these plurality of candidates into groups, and selects the second token sequence gₜ from the plurality of candidates based on the information representing the identifier.

The series of processes can be made equivalent to the process performed on a single token by processing one token sequence at a time. That is, in S100, the processor generates candidates for the second token sequence from the group of token sequences based on the joint probability of the tokens, generates a hash seed S from the first token sequence gₜ₋₁, calculates the hash values of the plurality of candidates, and classifies the plurality of candidates into groups, thereby achieving the same processing as described above for a single token.

Similarly to the above, the processor can also define token sequences with negative indices. For example, the processor can define tokens s₋₁₀ through s₋₁ as token sequence g₋₁, and so forth.

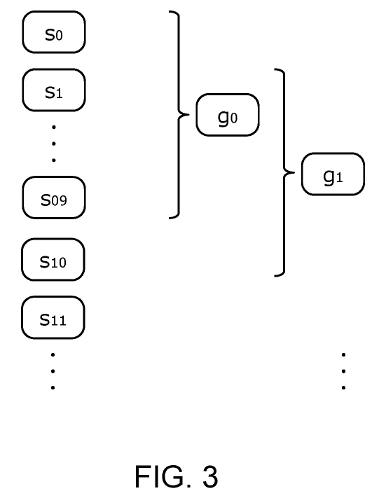

FIG. 3 is a diagram illustrating another example of using token sequences. As shown in this figure, it is also possible for multiple token sequences to share overlapping tokens. In this case, it is possible to generate and select candidates on a per-token basis, and even when token sequences share overlapping tokens, it is possible to calculate a hash value for each token sequence independently. This makes it possible to broaden the range of token selection and, by extension, to improve the robustness of the generated data.

By using multiple tokens as a token sequence, as shown in FIG. 2 or FIG. 3, it becomes possible to achieve appropriate embedding of information even in cases where processing on a per-token basis would result in low entropy.

In the above, the generation of tokens can be defined based on the generative model used by the information processing device.

The embedding of information using tokens or token sequences by the information processing device described above does not require information related to the generative model when reading the information. That is, the information processing device on the reading side can appropriately retrieve the embedded information even without having access to information about the generative model. Furthermore, since the information processing device on the reading side can retrieve the information without using the generative model, it can retrieve the embedded information through high-speed computation.

As described above, in the information processing device according to the present embodiment, the processor selects, from among token candidates that form data, a token to be included in the token sequence based on the embedding information, thereby embedding the embedding information in the data. For example, the processor can generate tokens that form data using a generative model and select tokens to be included in the token sequence output as data. Note that if the group of candidates can be classified without actually generating the token candidates, the token corresponding to the embedding information may be directly selected and generated without actually generating the candidates. This also applies to the description that follows.

The processor can select each token in this token sequence based on the bit corresponding to the bit sequence representing the embedding information.

That is, the information processing device generates, using a generative model, a plurality of candidates (tokens) for the second token that follows the already-generated and selected first token, classifies these candidates into a plurality of groups, and from this classification selects a token suited to the order that fits the bit sequence of the embedding information.

The information processing device can also generate candidates for the second token based on at least the already-generated and selected first token. Furthermore, the information processing device can select the second token based on at least the first token. More specifically, the information processing device can output candidates for the second token based on the first token in the generative model, and/or classify these candidates for the second token into groups based on the first token.

Of course, the token that is the target of embedding in the above may be a combination of multiple tokens (a token portion), as shown in FIG. 2 or FIG. 3. In other words, the information processing device may associate each bit of the bit sequence of the embedding information with a single token unit, or with a multiple-token unit. A token portion may be one token or multiple tokens.

### Embodiment Relating to Reading Device

As a non-limiting example, the information processing device retrieves information embedded in data using the digital watermark technique by the device described above. As noted above, the information processing device can retrieve the embedded information without using information related to the generative model.

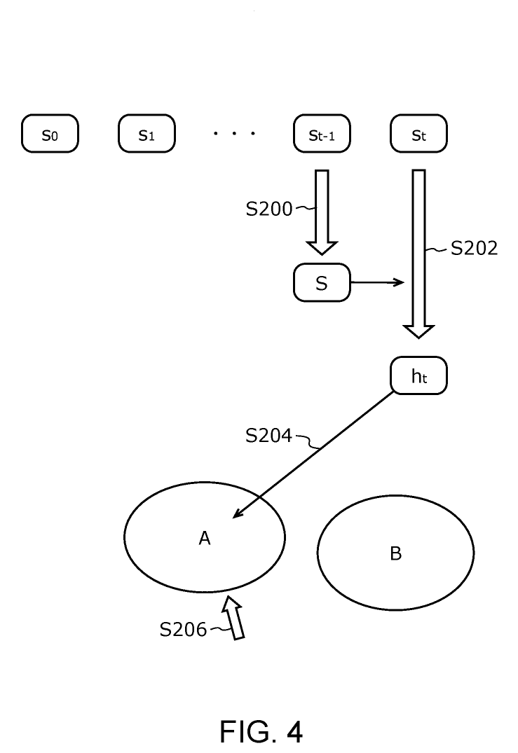

FIG. 4 is a diagram schematically illustrating an example of embedding information acquisition according to one embodiment. The data is data that can be divided into tokens, and the processor can retrieve the embedded information using the divided tokens.

Note that when one piece of embedding information is embedded across multiple token sequences, the processor can similarly retrieve the embedded information by processing each token sequence as shown in FIG. 2 and similar figures. That is, the processor can retrieve the information based on the conditions used for embedding. The user may determine in advance the format to be used for embedding, or may embed this information in the generated data and have the processor on the reading side extract the conditions before executing the process.

Similarly to S102, the processor obtains a hash seed S for calculating the hash value of the second token sₜ by applying a predetermined hash seed to the first token sₜ₋₁ (S200). The predetermined hash seed and the algorithm for calculating the hash seed S may be the same as those used in S102.

Similarly to S104, the processor calculates the hash value hₜ of the second token sₜ using the hash seed S (S202). The hashing algorithm may be the same as that used in S104.

Similarly to S106, the processor classifies the second token sₜ into a group based on the hash value hₜ (S204). The groups are the same groups into which the candidates for the second token are classified in S106. The classification rule may be the same as that used in S106.

The processor retrieves the value indicated by the second token sₜ (for example, the bit value corresponding to the group into which the second token sₜ was classified) based on the classified group (S206).

The processor retrieves the value indicated by each token as the second token by repeating the process from s₀ until the final token or until the embedding information of the required length is obtained, and by concatenating these values, can retrieve the embedded information (e.g., the identifier).

As described above, according to the present embodiment, the information processing device can appropriately retrieve information from data in which information has been embedded. The information processing device can retrieve the information embedded in the generated data at high speed without obtaining information related to the generative model used to generate the data.

### Application Example

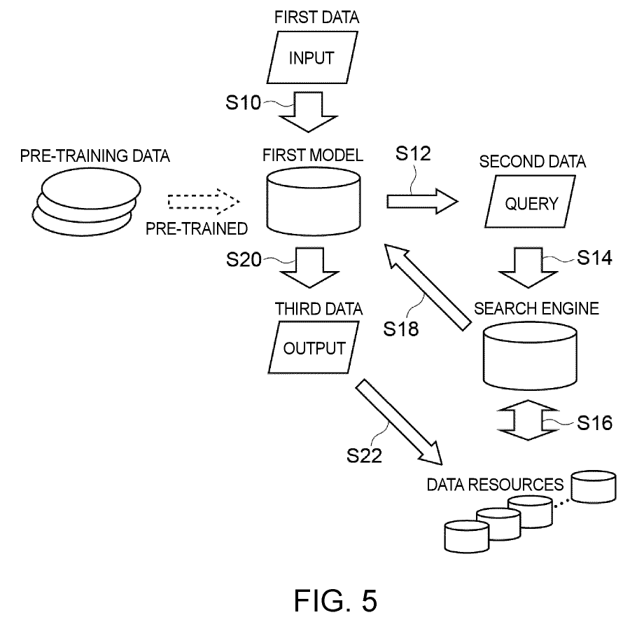

FIG. 5 is a diagram schematically illustrating a non-limiting example of utilizing the processing according to one embodiment described above. The processing in this figure may be executed in, for example, an information processing system comprising one or more processors mounted in one or more computers and one or more storage devices (including those provided within the computers). The information processing method described above can be partially applied in this information processing system.

The information processing system is a system that generates and outputs third data, which is output data for first data as input data, using a first model that is a probabilistic model trained using pre-training data. The first model may be, for example, a foundation model or a generative model.

The first data is, for example, text for posing a question to the first model, and is called a prompt. Depending on the context, the first data can be read as a question to which an answer is generated by the first model. Hereinafter, "question" may conceptually include both a question from a user and an instruction from a user. Furthermore, "question" may conceptually include both data input by a user and processed data obtained by performing predetermined processing on that data.

The first data may include any of images, audio, video, and sensor data. The third data is, for example, text representing an answer to a question. Hereinafter, "answer" may conceptually include both an answer to a question and a response to an instruction. Furthermore, "answer" may conceptually include both data generated by the first model and processed data obtained by performing predetermined processing on that data. The third data, like the first data, may include any of images, audio, video, and sensor data. Furthermore, both the first data and the third data are not limited to these types and may be data in other formats.

The first model is stored in a storage device within the information processing system, and is formed by the processor within the information processing system referencing this storage device. The information processing system executes inference using the first model formed by the processor.

The information processing system first receives the first data as input data (S10). The input of data may be performed with respect to at least one processor within the information processing system via various interfaces. At least one processor within the information processing system may receive, for example, first data input by a user as input data.

The first data input by the user is, for example, data input or specified by the user via the user interface of an information terminal, and may be text entered via a keyboard, text selected within a document, an image dragged and dropped with a mouse, or audio recorded by a microphone. Here, the user's information terminal is an example of an information processing device in the information processing system and is one element constituting the information processing system.

At least one processor within the information processing system acquires, based on the first data received as input data, second data for executing a search necessary for generating the third data (S12). The second data is, for example, a query to be input to a search engine. The information retrieved using this second data is utilized as additional input when determining the output of the third data. That is, the second data is data for searching for information related to a response to the first data.

At least one processor within the information processing system may, for example, tokenize the first data by inputting it to the trained first model, and acquire, based on the obtained tokens, a search query necessary for the search as the second data. As a non-limiting example, the first model may be a large language model, in which case the processor acquires the second data by extracting, from the tokenized first data, a search query for generating the third data in response to the first data representing an input question or the like.

At least one processor within the information processing system may also, for example, vectorize the first data and acquire the obtained vector as the second data, which is a query necessary for the search. Furthermore, at least one processor within the information processing system may acquire the first data itself as the second data, which is a query necessary for the search. At least one processor within the information processing system may also use conventional methods to acquire the second data, which is a query for the search engine described below, based on the first data.

At least one processor within the information processing system uses the acquired second data as a query to search, using a search engine, for information necessary for generating the third data (S14). The search engine, like the first model, is stored in a storage device within the information processing system, and is formed by at least one processor within the information processing system referencing this storage device. The information processing system executes a search for necessary information using the search engine formed by the processor.

The information processing system inputs the second data to the search engine and retrieves, from data sources, information to be used for generating the third data (S16). The processing by the search engine may be executed by at least one processor within the information processing system. Through this processing, the information processing system can, as a non-limiting example, retrieve information to be used for generating a response to the first data from the data sources based on the first data.

The processing by the search engine can be executed by, for example, using data in the data sources that is the search target as a key and extracting the key corresponding to the query. The key retrieval by the search engine is not limited to a predetermined method, and general methods for retrieving keys corresponding to queries can be used.

Additionally, the key and query may each be encoded. As one example, the search engine can execute the search using a function defined from the encoded key and the encoded query. This encoding of the key and query can also be pre-learned in advance at the time of pre-training the first model.

As a non-limiting example, when the first model is a large language model, at least one processor within the information processing system can generate a query necessary for the search from the tokenized text, and by referencing the keys of the data sources using this query, can extract information that may include text necessary for generating a response to the input text.

Furthermore, this search engine may be an engine formed by any method, such as keyword matching, a model formed using an attention mechanism, or a model formed using a reinforcement learning method. However, the engine is not limited to these and may be an engine formed by other methods.

At least one processor within the information processing system reflects the results retrieved by the search engine in the generation of output data in the first model (S18).

At least one processor within the information processing system generates the third data based on the input data received in S10 and the information retrieved by the search for generating the third data, which is the output data in the first model (S20). That is, at least one processor within the information processing system can generate a response to the first data using the first model with this information.

The information processing device according to the present disclosure described in the above embodiment generates the third data while embedding the embedding information in the processing of S20. The embedding information is, for example, an identifier as information about the provider of the information retrieved in S16.

The information processing device acquires, for example, a plurality of candidates for the second token from the first model at the timing of generating the third data. By executing an embedding process based on the processing of the aforementioned embodiment based on these plurality of candidates, the information processing device can embed, for example, an identifier indicating the information provider in the third data.

Note that the information processing device that generates the third data can use the tokens of the first data when generating the first one or more tokens of the third data. In this case, the information processing device that retrieves the embedding information from the third data can retrieve the embedding information, such as the bit values assigned to the first one or more processor tokens of the third data, by using the first data.

Of course, in this application example as well, the information processing device can execute processing not on a per-token basis, but on a per-token-sequence basis where a token sequence is formed from multiple tokens.

At least one processor within the information processing system may output the generated third data (answer) to the information terminal of the user who input the first data in S10. The output third data (answer) with the embedding information embedded therein may, for example, be displayed on the user's information terminal, read aloud by audio on the information terminal, or printed via the information terminal.

As an example, at least one processor within the information processing system can, by inputting the input data and the information retrieved by the search into the first model, generate a response or answer utilizing this information in addition to knowledge based on pre-training data, as third data in which the embedding information is embedded. As one example, at least one processor within the information processing system may process the input data and the information retrieved by the search into a prompt of a predetermined format and input this prompt to the first model to generate the third data.

As another non-limiting example, at least one processor within the information processing system may incorporate the information retrieved by the search into the first model as input to its internal computation, and then input the input data to the first model as a prompt to generate the third data. In this other example, the input interface for the information is designed as appropriate according to the architecture of the first model, and may be, for example, any of the input layer, intermediate layer, or output layer of the first model.

The first model can generate the third data using information of encoded keys set in the data resources. As a non-limiting example, when the first model is a large language model, the first model can retrieve the search results for the input text as an encoded embedding vector, and by reflecting the information of this encoded embedding vector in the output data, can generate text or the like with higher accuracy as an answer to a question or the like.

With this information processing system, an identifier can be embedded in the output data as an answer. This embedded data is, for example, an identifier indicating the information provider as described above.

At least one processor within the information processing system may calculate and assign a contribution score to the information retrieved from the data resources and used for generating the third data (S22). Note that in the present disclosure, the processing of S22 is not an essential process and is presented as one application example.

The contribution score is one example of a metric for evaluating the usefulness of information. The contribution score may be assigned at the timing when the information is provided to the data resources. Through this processing, the information processing system can, as a non-limiting example, calculate the contribution of information in the generation of an answer by the first model.

According to the embedding information of the present disclosure, it is possible to retrieve an identifier of the information provider from the output data, and based on this identifier, a contribution score can be set for the information provider. This embedding information, for example, will not be replaced by another identifier even if part of the tokens is tampered with or part of the tokens is deleted. Furthermore, because hashing — a process that is generally difficult to analyze — is involved, it is also difficult for a tamperer to rewrite the information to an arbitrary identifier through tampering or similar.

As noted above, this application example is presented as a non-limiting example, and the information embedding according to the present disclosure does not exclude other suitable applications beyond this application example.

Some or all of each device (such as the information processing device, etc.) in the above embodiment may be configured in hardware, or information processing of software (program) executed by, for example, a CPU (Central Processing Unit), GPU (Graphics Processing Unit). In the case of the information processing of software, software that enables at least some of the functions of each device in the above embodiments may be stored in a non-volatile storage medium (non-volatile computer readable medium) such as CD-ROM (Compact Disc Read Only Memory) or USB (Universal Serial Bus) memory, and the information processing of software may be executed by loading the software into a computer. In addition, the software may also be downloaded through a communication network. Further, entire or a part of the software may be implemented in a circuit such as an ASIC (Application Specific Integrated Circuit) or FPGA (Field Programmable Gate Array), wherein the information processing of the software may be executed by hardware.

A storage medium to store the software may be a removable storage media such as an optical disk, or a fixed type storage medium such as a hard disk, or a memory. The storage medium may be provided inside the computer (a main storage device or an auxiliary storage device) or outside the computer.

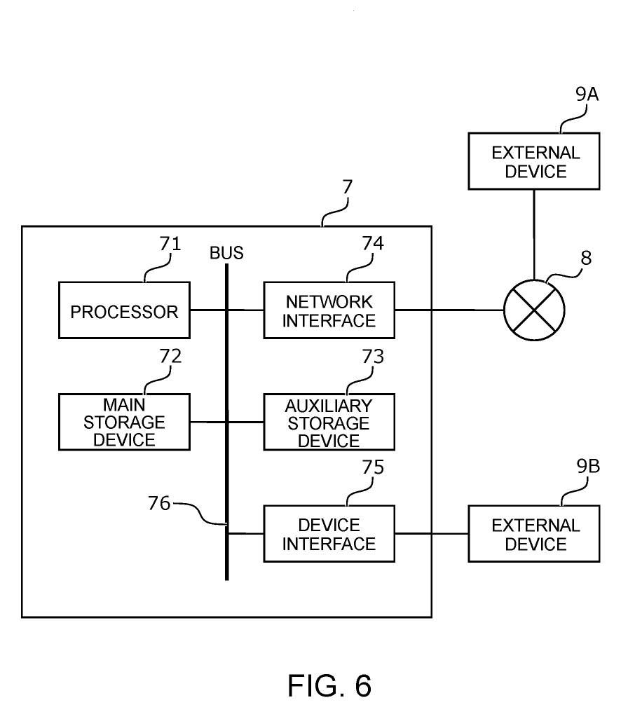

FIG. 6 is a block diagram illustrating an example of a hardware configuration of each device (such as the information processing device, etc.) in the above embodiments. As an example, each device may be implemented as a computer 7 provided with a processor 71, a main storage device 72, an auxiliary storage device 73, a network interface 74, and a device interface 75, which are connected via a bus 76.

The computer 7 of FIG. 6 is provided with each component one by one but may be provided with a plurality of the same components. Although one computer 7 is illustrated in FIG. 6, the software may be installed on a plurality of computers, and each of the plurality of computer may execute the same or a different part of the software processing. In this case, it may be in a form of distributed computing where each of the computers communicates with each of the computers through, for example, the network interface 74 to execute the processing. That is, each device (such as the information processing device, etc.) in the above embodiments may be configured as a system where one or more computers execute the instructions stored in one or more storages to enable functions. Each device may be configured such that the information transmitted from a terminal is processed by one or more computers provided on a cloud and results of the processing are transmitted to the terminal.

Various arithmetic operations of each device (such as the information processing device, etc.) in the above embodiments may be executed in parallel processing using one or more processors or using a plurality of computers over a network. The various arithmetic operations may be allocated to a plurality of arithmetic cores in the processor and executed in parallel processing. Some or all the processes, means, or the like of the present disclosure may be implemented by at least one of the processors or the storage devices provided on a cloud that can communicate with the computer 7 via a network. Thus, each device in the above embodiments may be in a form of parallel computing by one or more computers.

The processor 71 may be an electronic circuit (such as, for example, a processor, processing circuity, processing circuitry, CPU, GPU, FPGA, or ASIC) that executes at least controlling the computer or arithmetic calculations. The processor 71 may also be, for example, a general-purpose processing circuit, a dedicated processing circuit designed to perform specific operations, or a semiconductor device which includes both the general-purpose processing circuit and the dedicated processing circuit. Further, the processor 71 may also include, for example, an optical circuit or an arithmetic function based on quantum computing.

The processor 71 may execute an arithmetic processing based on data and / or a software input from, for example, each device of the internal configuration of the computer 7, and may output an arithmetic result and a control signal, for example, to each device. The processor 71 may control each component of the computer 7 by executing, for example, an OS (Operating System), or an application of the computer 7.

Each device (such as the information processing device, etc.) in the above embodiments may be enabled by one or more processors 71. The processor 71 may refer to one or more electronic circuits located on one chip, or one or more electronic circuitries arranged on two or more chips or devices. In the case of a plurality of electronic circuitries is used, each electronic circuit may communicate by wired or wireless.

The main storage device 72 may store, for example, instructions to be executed by the processor 71 or various data, and the information stored in the main storage device 72 may be read out by the processor 71. The auxiliary storage device 73 is a storage device other than the main storage device 72. These storage devices shall mean any electronic component capable of storing electronic information and may be a semiconductor memory. The semiconductor memory may be either a volatile or non-volatile memory. The storage device for storing various data or the like in each device (such as the information processing device, etc.) in the above embodiments may be enabled by the main storage device 72 or the auxiliary storage device 73 or may be implemented by a built-in memory built into the processor 71. For example, the storages 102 in the above embodiments may be implemented in the main storage device 72 or the auxiliary storage device 73.

In the case of each device (such as the information processing device, etc.) in the above embodiments is configured by at least one storage device (memory) and at least one processor connected/coupled to/with this at least one storage device, the at least processor may be connected to a single storage device. Or the at least storage may be connected to a single processor. Or each device may include a configuration where at least one of the plurality of processors is connected to at least one of the plurality of storage devices. Further, this configuration may be implemented by a storage device and a processor included in a plurality of computers. Moreover, each device may include a configuration where a storage device is integrated with a processor (for example, a cache memory including an L1 cache or an L2 cache).

The network interface 74 is an interface for connecting to a communication network 8 by wireless or wired. The network interface 74 may be an appropriate interface such as an interface compatible with existing communication standards. With the network interface 74, information may be exchanged with an external device 9A connected via the communication network 8. Note that the communication network 8 may be, for example, configured as WAN (Wide Area Network), LAN (Local Area Network), or PAN (Personal Area Network), or a combination of thereof, and may be such that information can be exchanged between the computer 7 and the external device 9A. The internet is an example of WAN, IEEE802.11 or Ethernet (registered trademark) is an example of LAN, and Bluetooth (registered trademark) or NFC (Near Field Communication) is an example of PAN.

The device interface 75 is an interface such as, for example, a USB that directly connects to the external device 9B.

The external device 9A is a device connected to the computer 7 via a network. The external device 9B is a device directly connected to the computer 7.

The external device 9A or the external device 9B may be, as an example, an input device. The input device is, for example, a device such as a camera, a microphone, a motion capture, at least one of various sensors, a keyboard, a mouse, or a touch panel, and gives the acquired information to the computer 7. Further, it may be a device including an input unit such as a personal computer, a tablet terminal, or a smartphone, which may have an input unit, a memory, and a processor.

The external device 9A or the external device 9B may be, as an example, an output device. The output device may be, for example, a display device such as, for example, an LCD (Liquid Crystal Display), or an organic EL (Electro Luminescence) panel, or a speaker which outputs audio. Moreover, it may be a device including an output unit such as, for example, a personal computer, a tablet terminal, or a smartphone, which may have an output unit, a memory, and a processor.

Further, the external device 9A or the external device 9B may be a storage device (memory). The external device 9A may be, for example, a network storage device, and the external device 9B may be, for example, an HDD storage.

Furthermore, the external device 9A or the external device 9B may be a device that has at least one function of the configuration element of each device (such as the information processing device, etc.) in the above embodiments. That is, the computer 7 may transmit a part of or all of processing results to the external device 9A or the external device 9B, or receive a part of or all of processing results from the external device 9A or the external device 9B.

In the present specification (including the claims), the representation (including similar expressions) of “at least one of a, b, and c” or “at least one of a, b, or c” includes any combinations of a, b, c, a - b, a - c, b - c, and a - b - c. It also covers combinations with multiple instances of any element such as, for example, a - a, a - b - b, or a - a - b - b - c - c. It further covers, for example, adding another element d beyond a, b, and / or c, such that a - b - c - d.

In the present specification (including the claims), the expressions such as, for example, “data as input,” “using data,” “based on data,” “according to data,” or “in accordance with data” (including similar expressions) are used, unless otherwise specified, this includes cases where data itself is used, or the cases where data is processed in some ways (for example, noise added data, normalized data, feature quantities extracted from the data, or intermediate representation of the data) are used. When it is stated that some results can be obtained “by inputting data,” “by using data,” “based on data,” “according to data,” “in accordance with data” (including similar expressions), unless otherwise specified, this may include cases where the result is obtained based only on the data, and may also include cases where the result is obtained by being affected factors, conditions, and / or states, or the like by other data than the data. When it is stated that “output/outputting data” (including similar expressions), unless otherwise specified, this also includes cases where the data itself is used as output, or the cases where the data is processed in some ways (for example, the data added noise, the data normalized, feature quantity extracted from the data, or intermediate representation of the data) is used as the output.

In the present specification (including the claims), when the terms such as “connected (connection)” and “coupled (coupling)” are used, they are intended as non-limiting terms that include any of “direct connection / coupling,” “indirect connection / coupling,” “electrical connection / coupling,” “communicative connection / coupling,” “operative connection / coupling,” “physical connection / coupling,” or the like. The terms should be interpreted accordingly, depending on the context in which they are used, but any forms of connection / coupling that are not intentionally or naturally excluded should be construed as included in the terms and interpreted in a non-exclusive manner.

In the present specification (including the claims), when the expression such as “A configured to B,” this may include that a physically structure of A has a configuration that can execute operation B, as well as a permanent or a temporary setting / configuration of element A is configured / set to actually execute operation B. For example, when the element A is a general-purpose processor, the processor may have a hardware configuration capable of executing the operation B and may be configured to actually execute the operation B by setting the permanent or the temporary program (instructions). Moreover, when the element A is a dedicated processor, a dedicated arithmetic circuit, or the like, a circuit structure of the processor or the like may be implemented to actually execute the operation B, irrespective of whether or not control instructions and data are actually attached thereto.

In the present specification (including the claims), when a term referring to inclusion or possession (for example, “comprising / including,” “having,” or the like) is used, it is intended as an open-ended term, including the case of inclusion or possession an object other than the object indicated by the object of the term. If the object of these terms implying inclusion or possession is an expression that does not specify a quantity or suggests a singular number (an expression with a or an article), the expression should be construed as not being limited to a specific number.

In the present specification (including the claims), although when the expression such as “one or more,” “at least one,” or the like is used in some places, and the expression that does not specify a quantity or suggests a singular number (the expression with a or an article) is used elsewhere, it is not intended that this expression means “one.” In general, the expression that does not specify a quantity or suggests a singular number (the expression with a or an as article) should be interpreted as not necessarily limited to a specific number.

In the present specification, when it is stated that a particular configuration of an example results in a particular effect (advantage / result), unless there are some other reasons, it should be understood that the effect is also obtained for one or more other embodiments having the configuration. However, it should be understood that the presence or absence of such an effect generally depends on various factors, conditions, and / or states, etc., and that such an effect is not always achieved by the configuration. The effect is merely achieved by the configuration in the embodiments when various factors, conditions, and / or states, etc., are met, but the effect is not always obtained in the claimed invention that defines the configuration or a similar configuration.

In the present specification (including the claims), when the term such as “maximize / maximization” is used, this includes finding a global maximum value, finding an approximate value of the global maximum value, finding a local maximum value, and finding an approximate value of the local maximum value, should be interpreted as appropriate accordingly depending on the context in which the term is used. It also includes finding on the approximated value of these maximum values probabilistically or heuristically. Similarly, when the term such as “minimize / minimization” is used, this includes finding a global minimum value, finding an approximated value of the global minimum value, finding a local minimum value, and finding an approximated value of the local minimum value, and should be interpreted as appropriate accordingly depending on the context in which the term is used. It also includes finding the approximated value of these minimum values probabilistically or heuristically. Similarly, when the term such as “optimize / optimization” is used, this includes finding a global optimum value, finding an approximated value of the global optimum value, finding a local optimum value, and finding an approximated value of the local optimum value, and should be interpreted as appropriate accordingly depending on the context in which the term is used. It also includes finding the approximated value of these optimal values probabilistically or heuristically.

In the present specification (including claims), when a plurality of hardware performs a predetermined process, the respective hardware may cooperate to perform the predetermined process, or some hardware may perform all the predetermined process. Further, a part of the hardware may perform a part of the predetermined process, and the other hardware may perform the rest of the predetermined process. In the present specification (including claims), when an expression (including similar expressions) such as “one or more hardware perform a first process and the one or more hardware perform a second process,” or the like, is used, the hardware that perform the first process and the hardware that perform the second process may be the same hardware, or may be the different hardware. That is: the hardware that perform the first process and the hardware that perform the second process may be included in the one or more hardware. Note that, the hardware may include an electronic circuit, a device including the electronic circuit, or the like.

In the present specification (including the claims), when a plurality of storage devices (memories) store data, an individual storage device among the plurality of storage devices may store only a part of the data or may store the entire data. Further, some storage devices among the plurality of storage devices may include a configuration for storing data.

An embodiment of the present disclosure is expressed as a non-limiting example, as follows:

(1) An information processing device comprising:

one or more memories; and

one or more processors configured to select, from among tokens generated by a generative model, a token to be included in a token sequence output as data, based on embedding information, thereby embedding the embedding information in the data.

(2) An information processing device comprising:

one or more memories; and

one or more processors configured to cause a generative model to output a token sequence in which the same embedding information is repeatedly embedded.

(3) The information processing device according to (1) or (2), wherein each token portion of the token sequence is selected from tokens generated by the generative model based on a corresponding bit in a bit sequence representing the embedding information.

(4) The information processing device according to (3), wherein the one or more processors: classify tokens generated by the generative model as candidates for a second token portion of the token sequence into a plurality of groups; and select, from tokens belonging to a group corresponding to a bit to be associated with the second token portion, a token to be output as the second token portion.

(5) The information processing device according to (4), wherein the one or more processors classify tokens generated by the generative model as candidates for the second token portion of the token sequence into a plurality of groups based on a first token portion preceding the second token portion.

(6) The information processing device according to (4), wherein the one or more processors: generate, using the generative model, candidates for a token of the second token portion based on a first token portion preceding the second token portion; and classify tokens generated by the generative model as candidates for the token of the second token portion into the plurality of groups based on the token selected as the first token portion.

(7) An information processing device comprising:

one or more memories; and

one or more processors configured to, for a token sequence formed by concatenating a predetermined number of tokens, which is one or more numbers:

transform, according to a predetermined rule, each of a plurality of candidates for a second token sequence generated based at least on a previously generated first token sequence;

classify the plurality of candidates into groups based on the results of the transformation;

select the second token sequence from the plurality of candidates such that data formed by concatenating the embedding information and candidates for append data indicated by the respective groups of the plurality of candidates constitutes a data sequence associated with the embedding information;

concatenate the second token sequence to the output data; and

concatenate the append data associated with the second token sequence to the embedding information.

(8) The information processing device according to (7), wherein the predetermined rule is a transformation that includes calculation of a hash value, and the one or more processors transform the plurality of candidates based on a predetermined hash seed and the first token sequence.

(9) The information processing device according to (8), wherein the one or more processors transform the plurality of candidates based on a hash value of the first token sequence transformed using the predetermined hash seed.

(10) The information processing device according to (9), wherein the one or more processors obtain a hash seed based on the hash value of the first token sequence transformed using the predetermined hash seed, and transform the plurality of candidates using the hash seed.

(11) The information processing device according to (7), wherein the one or more processors divide the plurality of candidates into a group representing 0 and a group representing 1.

(12) The information processing device according to (11), wherein the one or more processors select the second token sequence such that a data sequence formed by concatenating the embedding information and the candidates for append data indicated by the respective groups of the plurality of candidates constitutes part or all of the data sequence representing the embedding information.

(13) The information processing device according to (12), wherein the part of the data sequence representing the embedding information is prefix-match data of the data sequence representing the embedding information.

(14) The information processing device according to (12), wherein the one or more processors select the second token sequence such that the concatenated data sequence matches, currently or in the future, the bit sequence representing the identifier.

(15) The information processing device according to any one of (7) to (14), wherein, when the token sequence is a token sequence formed from a plurality of tokens, the one or more processors generate the second token sequence based on a joint probability of the plurality of tokens forming the second token sequence.

(16) The information processing device according to (7), wherein the one or more processors generate the plurality of candidates for the second token sequence using a generative model.

(17) The information processing device according to (7), wherein the one or more processors are configured to:

generate, after the embedding information has been generated as a data sequence associated with an identifier, an error detection code or error correction code for the data sequence associated with the identifier;

transform, according to a predetermined rule, each of a plurality of candidates for a second token sequence generated based at least on a previously generated first token sequence;

classify the plurality of candidates into groups based on the results of the transformation;

select, from the candidates for the second token sequence, the second token sequence into which the append data that becomes the error detection code or the error correction code is transformed;

concatenate the second token sequence to the output data; and

concatenate the append data associated with the second token sequence to the embedding information.

(18) The information processing device according to (7), wherein the embedding information is an identifier representing a predetermined type of information.

(19) An information processing device comprising:

one or more memories; and

one or more processors configured to:

divide data into a token sequence;

identify a bit corresponding to each token portion included in the token sequence; and

obtain, as embedding information embedded in the data, a bit sequence obtained by concatenating the bits corresponding to each token portion.

(20) The information processing device according to (19), wherein the one or more processors identify a bit corresponding to a next token portion based on a preceding token portion.

(21) An information processing device comprising:

one or more memories; and

one or more processors configured to:

divide data into token sequences each formed by concatenating a predetermined number of tokens, which is one or more numbers;

transform each token sequence according to a predetermined rule based on a token sequence preceding the token sequence;

classify the token sequence into a group based on the result of the transformation;

obtain a value based on the group;

concatenate the values of the respective token sequences; and

obtain, from the concatenated result, embedding information embedded in the data.

While certain embodiments of the present disclosure have been described in detail above, the present disclosure is not limited to the individual embodiments described above. Various additions, changes, substitutions, partial deletions, etc. are possible to the extent that they do not deviate from the conceptual idea and purpose of the present disclosure derived from the contents specified in the claims and their equivalents. For example, when numerical values or mathematical formulas are used in the description in the above-described embodiments, they are shown for illustrative purposes only and do not limit the scope of the present disclosure. Further, the order of each operation shown in the embodiments is also an example, and does not limit the scope of the present disclosure.

1. An information processing device comprising:
one or more processors; and
one or more memories storing processor-executable instructions that, when executed by the one or more processors, cause the one or more processors to:
acquire, using a generative model based on one or more preceding tokens, multiple tokens as candidates for a next token succeeding the one or more preceding tokens; and
select, from among the multiple tokens, a token as the next token based on information used for embedding a watermark, thereby embedding the watermark in an output token sequence.

2. The information processing device according to claim 1, wherein the one or more processors further calculate values for the multiple tokens based on at least a part of the one or more preceding tokens, and wherein the one or more processors select, from among the multiple tokens, the token as the next token based on the information used for embedding the watermark, the information including at least the values of the multiple tokens.

3. The information processing device according to claim 2, wherein each of the values for the multiple tokens is a value other than a probability of the generative model.

4. The information processing device according to claim 2, wherein the one or more processors further generate a seed based on at least the part of the one or more preceding tokens, and wherein the one or more processors calculate, based on the seed, the values for the multiple tokens.

5. The information processing device according to claim 4, wherein the seed is a hash seed generated by converting at least the part of the one or more preceding tokens into a hash value using another hash seed.

6. The information processing device according to claim 5, wherein the values for the multiple tokens are hash values, and the one or more processors calculate the hash values by hashing each of the multiple tokens using the generated hash seed.

7. The information processing device according to claim 2, wherein the token is selected, from among the multiple tokens, as the next token by:
assigning, to each of the multiple tokens, either a first binary value or a second binary value based on the values for the multiple tokens; and
selecting, from among the multiple tokens, the token as the next token based on the binary values assigned to the multiple tokens.

8. The information processing device according to claim 7,
wherein the first binary value is 0 and the second binary value is 1, and
wherein the token is selected from one or more tokens to which a binary value corresponding to at least a part of a binary bit sequence to be embedded as the watermark is assigned.

9. The information processing device according to claim 8, wherein the one or more processors further:
obtain the binary bit sequence to be embedded as the watermark; and
generate the output token sequence by, for each target bit of the binary bit sequence:
acquiring, using the generative model based on one or more preceding tokens, multiple tokens as candidates for a next token succeeding the one or more preceding tokens;
calculating values for the multiple tokens based on at least a part of the one or more preceding tokens;
assigning, to each of the multiple tokens, either the first binary value or the second binary value based on the values for the multiple tokens; and
selecting, from among the multiple tokens, a token to which a binary value corresponding to the target bit is assigned, as the next token.

10. The information processing device according to claim 8, wherein, for each target bit of the binary bit sequence, a token sequence including a predetermined number of tokens is selected such that the target bit is represented by the token sequence.

11. The information processing device according to claim 8, wherein after generating a part of the output token sequence in which the binary bit sequence is embedded, the one or more processors further generate an error detection code or an error correction code for the binary bit sequence, and select subsequent tokens to embed the error detection code or the error correction code in the output token sequence.

12. The information processing device according to claim 8, wherein the one or more processors repeatedly embed the binary bit sequence to be embedded as the watermark in the output token sequence.

13. The information processing device according to claim 1, wherein the token is selected, from among the multiple tokens, as the next token according to a sampling rule based on the information used for embedding the watermark.

14. The information processing device according to claim 1, wherein the one or more processors generate the output token sequence using the generative model based on information retrieved for generating the output token sequence, and wherein the watermark embedded in the output token sequence represents at least one of a provider of the retrieved information or the retrieved information.

15. The information processing device according to claim 1, wherein the watermark embedded in the output token sequence represents at least one of:
an entity that generates the output token sequence,
an entity that instructs generation of the output token sequence,
a date of generation of the output token sequence,
the generative model used to generate the output token sequence,
information indicating that copying of the output token sequence is prohibited, or
information indicating a permitted scope of use of the output token sequence.

16. The information processing device according to claim 1, wherein the watermark embedded in the output token sequence is detectable from the output token sequence without using information relating to the generative model.

17. An information processing device comprising:
one or more processors; and
one or more memories storing processor-executable instructions that, when executed by the one or more processors, cause the one or more processors to:
obtain data comprising a sequence of tokens;
calculate, for each target token included in the sequence of tokens, a value by:
generating a hash seed by converting at least a part of one or more preceding tokens before the target token into a first hash value using a predetermined initial hash seed; and
calculating the value based on the target token and the generated hash seed; and
detect a watermark embedded in the data by collectively evaluating the values calculated for a plurality of target tokens in the sequence of tokens,
wherein the watermark is detected without using information relating to a generative model that generates the sequence of tokens.

18. The information processing device according to claim 17, wherein calculating the value based on the target token and the generated hash seed includes:
calculating a second hash value by hashing the target token using the generated hash seed; and
determining the value based on the second hash value.

19. The information processing device according to claim 18, wherein the values calculated for the plurality of target tokens are binary bits, and detecting the watermark includes acquiring a bit sequence by concatenating the binary bits calculated for the plurality of target tokens and evaluating the bit sequence as information embedded as the watermark in the data.

20. A method performed by one or more processors, the method comprising:
acquiring, using a generative model based on one or more preceding tokens, multiple tokens as candidates for a next token succeeding the one or more preceding tokens; and
selecting, from among the multiple tokens, a token as the next token based on information used for embedding a watermark, thereby embedding the watermark in an output token sequence.
